(19) United States
(12) Patent Application Publication
(10) Pub. No.: US 2025/0385340 A1
(43) Pub. Date: Dec. 18, 2025

(54) HEAT INSULATING SHEET FOR RECHARGEABLE LITHIUM BATTERY AND RECHARGEABLE LITHIUM BATTERY MODULE INCLUDING THE SAME

(71) Applicant: SAMSUNG SDI CO., LTD., Yongin-si (KR)

(72) Inventors: Jae Hyun LEE, Suwon-si (KR); Myung Heui WOO, Suwon-si (KR); Jung Hyo LEE, Suwon-si (KR); Seung Yong YANG, Suwon-si (KR); Hye Jin PARK, Suwon-si (KR); Ha Na RA, Suwon-si (KR); Yun Sung YANG, Suwon-si (KR)

(73) Assignee: SAMSUNG SDI CO., LTD., Yongin-si (KR)

(21) Appl. No.: 19/228,106

(22) Filed: Jun. 4, 2025

(30) Foreign Application Priority Data
Jun. 14, 2024 (KR) 10-2024-0077637

(51) Int. Cl. H01M 10/658; B32B 5/02; B32B 7/027; B32B 27/30; B60L 50/64; H01M 10/052; H01M 10/625; H01M 10/647; H01M 50/209; H01M 50/293

(52) U.S. Cl. CPC H01M 10/658; B32B 5/022; B32B 7/027; B32B 27/306; H01M 10/052; H01M 10/625; H01M 10/647; H01M 50/209; H01M 50/293; B32B 2260/021; B32B 2260/046; B32B 2262/101; B32B 2307/304; B32B 2307/72; B32B 2307/737; B32B 2457/10; B60L 50/64; H01M 2220/20

(57) ABSTRACT

The present disclosure relates to a heat insulating sheet for a rechargeable lithium battery, and a rechargeable lithium battery module including the heat insulating sheet. The heat insulating sheet for a rechargeable lithium battery includes a first base layer, an aerogel-containing layer, and a second base layer that are stacked together. The aerogel-containing layer includes a thermally conductive material-containing region, and a thermally conductive material is dispersed at high density in the thermally conductive material-containing region.

### CROSS-REFERENCE TO RELATED APPLICATION

The present application claims the benefit of priority to Korean Patent Application No. 10-2024-0077637, filed on Jun. 14, 2024 in the Korean Intellectual Property Office, the entire disclosure of which being incorporated herein by reference.

### BACKGROUND

### 1. Field of the Disclosure

The present disclosure relates to a heat insulating sheet for a rechargeable lithium battery, and a rechargeable lithium battery module including the heat insulating sheet.

### 2. Discussion of Related Art

With increasing presence of electronic devices that use batteries, such as, e.g., mobile phones, laptop computers, electric vehicles, and the like, the demand for rechargeable batteries with high energy density and high capacity has increased. Accordingly, improving performance of rechargeable lithium batteries may be advantageous.

A rechargeable lithium battery typically includes a positive electrode and a negative electrode including an active material which allows for intercalation and deintercalation of lithium ions and an electrolyte, and produces electrical energy through an oxidation-reduction reaction taking place when the lithium ions are intercalated and deintercalated to and from the positive electrode and the negative electrode.

A plurality of rechargeable lithium batteries may be included to form a rechargeable lithium battery module. It may be advantageous for heat propagation and/or heat transfer to be reduced or blocked between adjacent cells in the rechargeable lithium battery module.

### SUMMARY

One example embodiment includes a heat insulating sheet for a rechargeable lithium battery that has desired or improved heat insulating performance, compression properties, and flexibility.

Another example embodiment includes a rechargeable lithium battery module including the heat insulating sheet for a rechargeable lithium battery.

A heat insulating sheet for a rechargeable lithium battery according to one includes embodiment includes a first base layer, an aerogel-containing layer, and a second base layer that are stacked, e.g., sequentially stacked. The aerogel-containing layer includes a thermally conductive material-containing region, and a thermally conductive material is dispersed, e.g., at high density, in the thermally conductive material-containing region.

Another example embodiment includes a rechargeable lithium battery module including a plurality of battery cells that face each other, and heat insulating sheets between the plurality of battery cells.

### BRIEF DESCRIPTION OF THE DRAWINGS

FIG. 1 is a cross-sectional view of a heat insulating sheet for a rechargeable lithium battery, according to one example embodiment.

FIG. 2 is a plan view along I-II of the cross-sectional view of FIG. 1.

FIG. 3 is a cross-sectional view of a heat insulating sheet for a rechargeable lithium battery, according to another example embodiment.

FIG. 4 is a perspective view of a rechargeable lithium battery module, according to one example embodiment.

FIG. 5 is an exploded perspective view of the rechargeable lithium battery module, according to one example embodiment.

FIG. 6 is a cross-sectional view schematically illustrating a battery cell, according to one example embodiment.

FIG. 7 is a cross-sectional view schematically illustrating a battery pack, according to one example embodiment.

FIG. 8 is a cross-sectional view schematically illustrating a battery pack, according to one example embodiment.

FIG. 9 is a view illustrating a vehicle body and vehicle body components, according to one example embodiment.

FIG. 10 is a view illustrating a vehicle body and vehicle body components, according to one example embodiment.

FIG. 11 is a cross-sectional view of a heat insulating sheet of Comparative Example 2 and Comparative Example 3.

FIG. 12 is a cross-sectional view of a heat insulating sheet of Comparative Example 4.

### DETAILED DESCRIPTION

Hereinafter, example embodiments of the present disclosure are described in detail. However, the embodiments are presented as examples, and the present disclosure is not limited by the embodiments. The present disclosure is defined only by the scope of the claims below.

Unless particularly mentioned otherwise in the present specification, when a part such as a layer, film, region, plate, or the like is described as being “on” another part, this not only includes a case in which the part is “directly on” the other part, but also includes a case in which still another part is present therebetween.

Unless particularly mentioned otherwise in the present specification, a singular expression may include a plural expression. Further, unless particularly mentioned otherwise, “A or B” may indicate including A, including B, or including A and B.

In the present specification, “a combination thereof” may indicate a mixture, stack, composite, copolymer, alloy, blend, and reaction product of constituents.

When the terms “about” or “substantially” are used in this specification in connection with a numerical value, it is intended that the associated numerical value include a tolerance of +10% around the stated numerical value. When ranges are specified, the range includes all values therebetween such as increments of 0.1%.

Heat insulating sheet for rechargeable lithium battery:

A heat insulating sheet for a rechargeable lithium battery according to one example embodiment includes a first base layer, an aerogel-containing layer, and a second base layer that are stacked, e.g., sequentially stacked, wherein the aerogel-containing layer includes a thermally conductive material-containing region, and a thermally conductive material is dispersed at high density in the thermally conductive material-containing region.

Hereinafter, a heat insulating sheet according to one example embodiment is described in detail.

### First Base Layer

The first base layer may support the aerogel-containing layer and the second base layer in the heat insulating sheet.

The first base layer may be included as one or more layers, that is, one layer or two or more layers, in the heat insulating sheet.

The first base layer may be or include a film, a thin film, or a sheet that is formed of or include at least one of a resin, a metal-based inorganic material, a nonmetal-based inorganic material, or a composite thereof or includes the same.

For example, the resin may include one or more of a polyolefin-based resin such as polyethylene or polypropylene, a polystyrene-based resin, a polyester-based resin such as polyethylene terephthalate or polybutylene terephthalate, a polyamide-based resin, and a polyimide-based resin.

For example, the metal-based inorganic material may include one or more of copper, nickel, cobalt, iron, chromium, vanadium, palladium, ruthenium, rhodium, molybdenum, tungsten, iridium, silver, gold, and platinum. The metal-based inorganic material may undergo anti-corrosion treatment, insulation treatment, or the like, when necessary.

The nonmetal-based inorganic material may include one or more of calcium carbonate, talc, and mica.

According to one example embodiment, the heat insulating sheet may include a nonmetal-based inorganic material, for example, a mica sheet, as the first base layer.

Mica may increase the compressibility, heat insulating performance, and durability of the heat insulating sheet.

The thickness of the first base layer may range from about 10 μm to about 5,000 μm, for example, from 50 μm to 3,000 μm, or from 100 μm to 1,000 μm. Within the above range, the first base layer may be included in the heat insulating sheet.

### Second Base Layer

The second base layer may support the first base layer and the aerogel-containing layer in the heat insulating sheet.

The second base layer may be included as one or more layers, that is, one layer or two or more layers, in the heat insulating sheet.

The second base layer may be stacked on the aerogel-containing layer. The aerogel-containing layer may be or include a separate layer that is independent of the second base layer. Herein, “separate layer that is independent of” indicates that the second base layer and the aerogel-containing layer are completely separated, or substantially completely separated, and formed as noncontinuous layers, instead of the aerogel-containing layer being formed through impregnation or the like in the second base layer.

The second base layer may be or include a film, a thin film, or a sheet that is formed of or include at least one of a resin, a metal-based inorganic material, a nonmetal-based inorganic material, or a composite thereof or includes the same. The resin, metal-based inorganic material, and nonmetal-based inorganic material are substantially the same as the resin, metal-based inorganic material, and nonmetal-based inorganic material described for the first base layer.

According to one example embodiment, the heat insulating sheet may include a nonmetal-based inorganic material as the second base layer. For example, the heat insulating sheet may include mica. Mica may increase the heat insulating performance and durability of the heat insulating sheet.

The second base layer may have a thickness ranging from about 10 μm to about 5,000 μm, for example, from 50 μm to 3,000 μm or from 100 μm to 1,000 μm. Within the above range, the second base layer may be included in the heat insulating sheet.

### Aerogel-Containing Layer

The aerogel-containing layer may be or include a separate layer that is independent of the first base layer and the second base layer. Herein, “separate layer that is independent of” indicates that the first base layer, the second base layer, and the aerogel-containing layer are completely separated, or substantially completely separated, and formed as noncontinuous layers, instead of the aerogel-containing layer being formed through impregnation or the like in the first base layer or the second base layer.

The aerogel-containing layer may be included as one or more layers, that is, one layer or two or more layers, in the heat insulating sheet.

The aerogel-containing layer may include a fibrous support, an aerogel, a binder, and a thermally conductive material.

The fibrous support may help support the aerogel-containing layer and improve the compressibility of the heat insulating sheet. The compressibility may mitigate the stress applied to the heat insulating sheet when volume expansion occurs during charging and discharging of batteries in a module when the heat insulating sheet is placed between the batteries, and may decrease the influence of the batteries in the event of a fire.

The fibrous support may be or include, for example, at least one of a wool mat or a chopped strand mat.

Fibers constituting the fibrous support may include one or more of natural fibers, glass fibers, carbon fibers, graphite fibers, mineral fibers, and polymer fibers. For example, the compression properties of the heat insulating sheet may be further increased when the glass fibers are included as the fibrous support.

The natural fibers may be or include fibers made of or including one or more of hemp, jute, flax, coir, kenaf, and cellulose. The mineral fibers may be or include fibers made of or including one or more of basalt, wollastonite, alumina, silica, slag, and rock. The polymer fibers may include one or more of nylon-based fibers, polyimide-based fibers, polyamide-based fibers, polybenzimidazole-based fibers, polybenzoxazole-based fibers, polyamideimide-based fibers, polyester-based fibers such as polyethylene terephthalate or polybutylene terephthalate, and polyolefin-based fibers such as polyethylene or polypropylene.

For example, the fibrous support may be or include glass wool.

Fibers in the fibrous support may have an aspect ratio of about 1 or more, for example, an aspect ratio ranging from about 1 to about 5,000, from 200 to 4,900, or from 200 to 1,000. Within the above range, the aerogel-containing layer can be firmly formed, and the durability of the heat insulating sheet can be increased. Herein, “aspect ratio” refers to a ratio of a fiber length to a fiber diameter in the fibrous support.

The fibers in the fibrous support may have a length ranging from about 50 μm to about 1,000 μm, for example, from 70 μm to 800 μm, or from 100 μm to 600 μm. Within the above range, the aerogel-containing layer can be firmly formed, and the durability of the heat insulating sheet can be increased.

The fibers in the fibrous support may have a diameter ranging from about 0.1 μm to about 20 μm, for example, from 0.1 μm to 15 μm, from 0.1 μm to 5 μm, from 1 μm to 15 μm, or from 3 μm to 10 μm. Within the above range, the aerogel-containing layer can be firmly formed, and the durability of the heat insulating sheet can be increased. Herein, “diameter” may refer to a diameter when the fibers have a circular cross-section, and may refer to the longest diameter when the cross-section is not circular.

The fibrous support may be included in an amount ranging from about 10 wt % to 70 about wt % in the aerogel-containing layer. For example, the fibrous support may be included in an amount ranging from 10 wt % to 60 wt % or from 20 wt % to 50 wt % in the aerogel-containing layer. Within the above range, it may be possible to increase the flexibility and durability of the heat insulating sheet.

The aerogel may provide a heat insulating effect to the aerogel-containing layer.

According to one example embodiment, the aerogel may have a specific surface area ranging from about 500 m²/g to about 1,000 m²/g. For example, the specific surface area may range from 500 m²/g to 1,000 m²/g, from 550 m²/g to 950 m²/g, or from 600 m²/g to 900 m²/g. Within the above range, it may be possible to reduce or prevent heat transfer and heat propagation between a plurality of battery cells. Herein, “specific surface area” may be a specific surface area based on Brunauer, Emmett and Teller (BET) specific surface area analysis.

According to one example embodiment, the aerogel may have an average particle diameter ranging from about 5 μm to about 200 μm. For example, the aerogel may have an average particle diameter ranging from 10 μm to 100 μm or from 20 μm to 50 μm. Within the above range, it may be possible to delay heat transfer between a plurality of battery cells by increasing the heat insulating performance of the heat insulating sheet. Herein, “particle diameter” refers to an average particle diameter D50, which is a diameter of a particle with a cumulative volume of 50% by volume in a particle diameter distribution. The average particle diameter D50 may be measured by methods known to those skilled in the art. For example, the average particle diameter D50 may be measured using a particle size analyzer, a transmission electron microscope photograph, or a scanning electron microscope photograph. As another method, an average particle diameter D50 value may be obtained by measuring the particle diameter using a measuring device using dynamic light-scattering, performing data analysis to count the number of particles for each particle size range, and calculating the particle diameter therefrom. Alternatively, an average particle diameter D50 may be measured using a laser diffraction method. For example, when measuring an average particle diameter D50 using a laser diffraction method, particles to be measured may be dispersed in a dispersion medium, introduced into a commercially available laser diffraction particle diameter measurement apparatus (for example, MT3000 of Microtrac, Inc.), and irradiated with ultrasonic waves of about 28 kHz at an output of 60 W, and then the average particle diameter D50 may be calculated based on 50% of a particle diameter distribution in the measurement apparatus.

According to one example embodiment, the aerogel may be treated to be hydrophobic.

The aerogel may be included in an amount ranging from about 10 wt % to about 90 wt % in the aerogel-containing layer. For example, the aerogel may be included in an amount ranging from 10 wt % to 70 wt %, from 30 wt % to 70 wt %, or from 40 wt % to 60 wt % in the aerogel-containing layer. Within the above range, the heat insulating performance of the heat insulating sheet can be increased.

The binder may make it possible to increase the dust resistance and mechanical properties of the heat insulating sheet.

According to one example embodiment, the binder may be or include an aqueous binder. The aqueous binder may be configured to facilitate the formation of the aerogel-containing layer due to being highly soluble in water among solvents described below.

According to one example embodiment, the aqueous binder may include one or more of a cationic aqueous polymer, an anionic aqueous polymer, and a nonionic aqueous polymer.

The cationic aqueous polymer may be or include a polymer having a functional group such as at least one of an amine group, an ammonium group, a phosphonium group, a sulfonium group, or a salt thereof, for example, a polymer having an amine group. For example, the cationic aqueous polymer may include one or more of polyethylene amine and polyamine.

The anionic aqueous polymer may be or include a polymer having a functional group such as at least one of a carboxylic acid group, a sulfonic acid group, an ester group, a phosphoric acid ester group, or a salt thereof, for example, a polymer having a carboxylic acid group. For example, the anionic aqueous polymer may be or include polymaleic acid.

The nonionic aqueous polymer may include one or more of polyvinyl alcohol, polyethylene glycol, polyacrylamide, polyvinyl pyrrolidone, polyurethane, and polyester. The nonionic aqueous polymer may be or include a water-dispersible or aqueous polymer.

According to one example embodiment, the binder may include a mixture of one or more of polyvinyl alcohol, polyethylene glycol, polyacrylamide, and polyvinyl pyrrolidone; and one or more of polyurethane and polyester. For example, it may be possible to provide dispersion characteristics by one or more of polyvinyl alcohol, polyethylene glycol, polyacrylamide, and polyvinyl pyrrolidone, and fire resistance properties by one or more of polyurethane and polyester. For example, a mixture of polyvinyl alcohol and polyurethane may be included.

According to one example embodiment, a weight ratio of one or more of polyvinyl alcohol, polyethylene glycol, polyacrylamide, and polyvinyl pyrrolidone to one or more of polyurethane and polyester may range from about 1:1 to about 1:5, for example, from 1:1 to 1:4 or from 1:2 to 1:3. Within the above range, the heat insulating performance, dust resistance, fire resistance, and mechanical properties of the heat insulating sheet can be improved.

The binder may be included in an amount ranging from about 0.5 wt % to about 20 wt % in the aerogel-containing layer. For example, the binder may be included in an amount ranging from 2 wt % to 15 wt % or from 8 wt % to 15 wt % in the aerogel-containing layer. Within the above range, it may be possible to improve the dust resistance of the heat insulating sheet.

The aerogel-containing layer includes a thermally conductive material. The aerogel-containing layer includes a thermally conductive material-containing region, and the thermally conductive material is dispersed at high density in the thermally conductive material-containing region.

The thermally conductive material does not release heat entering the aerogel-containing layer, but instead, substantially traps heat in the material itself to reduce or prevent the heat from being released to the outside, thereby increasing the heat insulating performance of the heat insulating sheet, and substantially evenly distributes parts where heat can be concentrated locally in the heat insulating sheet in the in-plane direction, thereby reducing or preventing rapid deterioration of the heat insulating sheet due to local heat concentration.

In the aerogel-containing layer, the thermally conductive material is neither dispersed throughout the aerogel-containing layer nor included in the form of a sheet or a mesh.

Instead, a region in which the thermally conductive material is dispersed at high density in a specific portion in a depth direction is partially present in the aerogel-containing layer. Because the region in which the thermally conductive material is dispersed at high density (hereinafter, may be referred to as “first region”) is present in this way, as compared to the case in which the thermally conductive material is included in the form of a sheet or a mesh, the aerogel-containing layer can include relatively more aerogel, thereby further increasing heat insulating performance. Also, because the region in which the thermally conductive material is dispersed at high density is partially present in the aerogel-containing layer, the compressibility and flexural modulus of the heat insulating sheet can be substantially maintained or increased. The heat insulating sheet can exhibit the effects of reducing stress due to swelling in the charging and discharging processes of cells and increasing the service life of a module by having a high compression rate, and can secure desired or improved flexibility by having a lower flexural modulus.

Herein, “thermally conductive material is dispersed at high density” may indicate that the thermally conductive material is present at a density of about 0.02 to about 7.46×10¹² per unit area (1 cm2).

The aerogel-containing layer also has a region not including the thermally conductive material (hereinafter, may be referred to as “second region”). For example, a region not including the thermally conductive material, a region in which the thermally conductive material is dispersed at high density, and a region not including the thermally conductive material, may be formed, e.g., sequentially formed, from the first base layer in the aerogel-containing layer.

The thermally conductive materials may be dispersed at a predetermined separation distance from each other in the thermally conductive material-containing region. For example, the separation distance between the thermally conductive materials may be about 1 nm or more, for example, may range from about 3 nm to about 1,000 nm. Within the above range, the thermally conductive materials may be included in the aerogel-containing layer.

Any thermally conductive material known to those skilled in the art may be included without limitation as the thermally conductive material. For example, the thermally conductive material may be or include metals such as at least one of titanium, copper, tin, aluminum, silicon, zirconium, zinc, and iron; metal oxides such as at least one of silica (SiO₂), alumina (Al₂O₃), titania (TiO₂), zirconia (ZrO₂), tin oxide (SnO₂), zinc oxide (ZnO), or iron oxide; metal carbides such as at least one of beryllium carbide (Be₂C), titanium carbide (TiC), or silicon carbide (SiC); metal nitrides such as at least one of vanadium nitride (VN), titanium nitride (TiN), molybdenum nitride (Mo₂N), tungsten nitride (TuN), niobium nitride (NbN), titanium nitride (TiN), or boron nitride (BN); metal hydroxides such as at least one of magnesium hydroxide (Mg(OH₂)) or aluminum hydroxide (Al(OH)₃); metal salts such as calcium carbonate (CaCO₃); silicate compounds such as at least one of Ca₃SiO₅ (tricalcium silicate), Ca₂SiO₄ (dicalcium silicate), or CaSiO₃ (calcium metasilicate); graphite such as at least one of natural graphite or artificial graphite; carbon-based materials such as at least one of carbon black, acetylene black, ketjen black, channel black, furnace black, lamp black, thermal black, or carbon fibers; ceramic particles such as at least one of yttria stabilized zirconia (YSZ), calcia stabilized zirconia (CSZ), scandia-stabilized zirconia (SSZ), or Ni-YSZ cermet; or pigments including a metal such as iron or manganese, and any one of the above or a mixture of two or more of the above may be included as the thermally conductive material.

In one example embodiment, the thermally conductive material may include one or more of titania, copper, aluminum, and carbon black.

Although the shape of the thermally conductive material is not particularly limited, the thermally conductive material may be or include solid-phase powder or nanoparticles. According to one example embodiment, the thermally conductive material may have an average particle diameter D50 ranging from about 10 nm to about 5,000 nm, for example, 10 nm to 100 nm, for example, 500 nm to 5,000 nm. Within the above range, the thermally conductive material may have an effect of increasing heat insulating performance, and may be included in the aerogel-containing layer.

The thermally conductive material may be included in an amount ranging from about 0.001 wt % to about 10 wt %, for example, from 0.001 wt % to 3 wt %, for example, from 1 wt % to 5 wt %, in the aerogel-containing layer. Within the above range, there may be an effect of increasing heat insulating performance without decreasing compressibility and increasing the flexural modulus.

The aerogel-containing layer may further include one or more of a dispersant and a silane-based compound.

The dispersant may improve the dispersion of the aerogel in the composition for the aerogel-containing layer, thereby enabling the preparation of an aerogel-containing layer in which the fibrous support and the aerogel are substantially uniformly dispersed.

The dispersant may include one or more of a surfactant and a phosphorous-based salt. The surfactant may include one or more of a nonionic surfactant, an anionic surfactant, and a zwitterionic surfactant. The surfactant may include one or more of a natural surfactant such as lecithin, and a non-natural surfactant such as a chemical. The phosphorous-based salt may be or include a phosphate-based salt.

The dispersant may be included in an amount ranging from about 0.1 wt % to about 6 wt % in the aerogel-containing layer. For example, the dispersant may be included in an amount ranging from 0.1 wt % to 5 wt % or from 0.1 wt % to 3 wt %. Within the above range, the composition for the aerogel-containing layer can be prepared at low cost, and a heat insulating sheet with improved heat insulating performance, durability, and dust resistance can be provided.

According to one example embodiment, the binder: the dispersant weight ratio may range from about 1:0.001 to about 1:0.7, for example, from 1:0.001 to 1:0.67, from 1:0.001 to 1:0.5, or from 1:0.001 to 1:0.3. Within the above range, when the binder and the dispersant are included together, it is possible to prepare an aerogel-containing layer in which the aerogel is further substantially uniformly dispersed.

The silane-based compound may improve the dispersibility of the aerogel in the aerogel-containing layer.

According to one example embodiment, the silane-based compound may include one or more of an alkyl group-containing trialkoxysilane such as methyltrimethoxysilane, methyltriethoxysilane, ethyltrimethoxysilane, ethyltriethoxysilane, or octadecyltrimethoxysilane, an epoxy group-containing trialkoxysilane such as glycidoxpropyltrimethoxysilane, and an unsaturated group-containing trialkoxysilane such as 3-(trimethoxysilyl) propyl methacrylate.

The aerogel-containing layer may further include a typical additive known to those skilled in the art. The additive may include one or more of a wetting agent, an emulsifier, a compatibilizer, a viscosity modifier, a pH regulator, a stabilizer, an antioxidant, an acid or base trapping agent, a metal deactivator, a defoamer, an antistatic agent, a thickener, an adhesion improver, a bonding agent, a flame retardant, an impact modifier, a pigment, a dye, a colorant, and a deodorant.

According to one example embodiment, the aerogel-containing layer may have a thickness ranging from about 100 μm to about 10,000 μm, for example, from 500 μm to 5,000 μm or from 1,000 μm to 3,000 μm. An aerogel-containing layer having a thickness within the above range may be included in the heat insulating sheet.

The aerogel-containing layer may be formed using a composition for an aerogel-containing layer that includes the fibrous support, the aerogel, and the binder and the thermally conductive material. The composition for an aerogel-containing layer may further include one or more of the dispersant, the silane-based compound, and the additive.

In one example embodiment, the composition for an aerogel-containing layer may include, based on solid content, about 5 wt % to about 70 wt %, for example, 25 wt % to 60 wt %, or 30 wt % to 50 wt %, of the fibrous support; about 10 wt % to about 90 wt %, for example, 30 wt % to 70 wt % or 40 wt % to 60 wt %, of the aerogel; and about 0.5 wt % to about 20 wt %, for example, 2 wt % to 15 wt % or 8 wt % to 15 wt %, of the binder.

A method of preparing the aerogel-containing layer is described below.

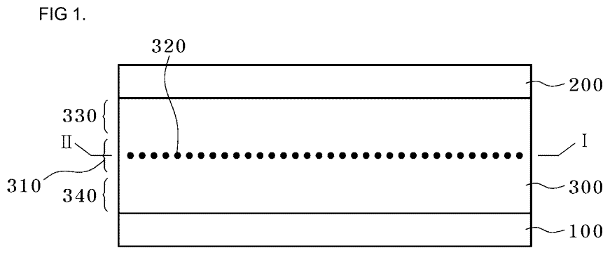

FIGS. 1 to 3 are cross-sectional views of a heat insulating sheet for a rechargeable lithium battery, according to one example embodiment.

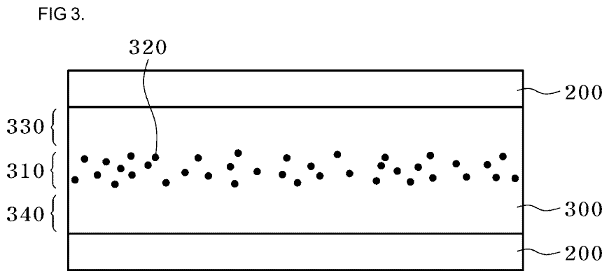

Referring to FIGS. 1 and 3, a heat insulating sheet for a rechargeable lithium battery includes a first base layer 100 and a second base layer 200, and further includes an aerogel-containing layer 300 between the first base layer 100 and the second base layer 200. A region 340 without a thermally conductive material 320, a region 310 in which the thermally conductive material 320 is dispersed at high density, and a region 330 without the thermally conductive material 320, may be formed, e.g., sequentially formed, from the first base layer 100 in the aerogel-containing layer 300.

A thickness ratio of the region 340 without the thermally conductive material 320, the region 310 in which the thermally conductive material 320 is dispersed at high density, and the region 330 without the thermally conductive material 320 in the aerogel-containing layer 300 may be in a range of about 20% to 60%: 1% to 20%: 20% to 60% when the overall thickness of the aerogel-containing layer 300 is 100%.

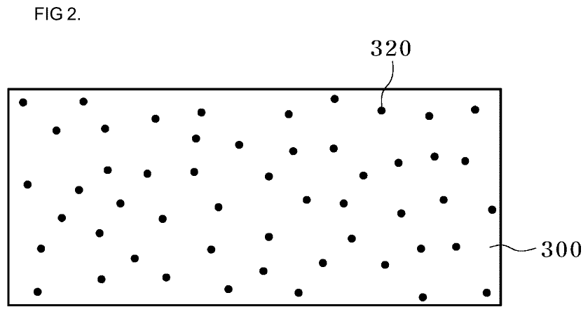

FIG. 2 is a plan view along I-II of the heat insulating sheet of FIG. 1.

Referring to FIG. 2, the thermally conductive materials 320 are dispersed at a separation distance, e.g., an arbitrary separation distance, from each other in the aerogel-containing layer 300.

Hereinafter, a method of preparing the heat insulating sheet according to one example embodiment is described.

The method of preparing the heat insulating sheet may include preparing a composition for an aerogel-containing layer that includes a fibrous support, an aerogel, and a binder, coating a first base layer with the composition for the aerogel-containing layer, dispersing thermally conductive materials therein, covering with a second base layer, and drying the composition for the aerogel-containing layer coated on the first base layer.

The method of preparing the heat insulating sheet may include preparing a composition for an aerogel-containing layer that includes a fibrous support, an aerogel, and a binder, coating a first base layer with the composition for the aerogel-containing layer, dispersing thermally conductive materials therein, coating with the composition for the aerogel-containing layer, covering with a second base layer, and drying the coated composition for the aerogel-containing layer.

The fibrous support, the aerogel, and the binder may be the same as the fibrous support, the aerogel, and the binder described above. The composition for the aerogel-containing layer may further include one or more of the above-described dispersant, silane-based compound, and additive.

The composition for the aerogel-containing layer may further include a solvent. The solvent may include one or more of a polar solvent and a nonpolar solvent.

The polar solvent may include water, an alcohol-based solvent, or a combination thereof. For example, the water may include purified water, deionized water, or a combination thereof. For example, the alcohol-based solvent may include one or more of methanol, ethanol, propanol, pentanol, butanol, hexanol, ethylene glycol, propylene glycol, diethylene glycol, and glycerol.

The nonpolar solvent may include a hydrocarbon-based solvent. For example, the hydrocarbon-based solvent may include one or more of an aliphatic hydrocarbon solvent such as at least one of hexane, pentane, or heptane, for example, an alkane solvent, and an aromatic hydrocarbon solvent such as at least one of toluene or benzene.

For example, the solvent may include water. When the water is included as the solvent, raw material costs and postprocessing costs can be effectively reduced.

The solvent may be included so that a weight ratio between the solvent and the total solid content of the composition for the aerogel-containing layer ranges from about 1:1 to about 1:90. For example, the solvent:total solid content weight ratio of the composition for the aerogel-containing layer may range from 1:50 to 1:70, from 1:20 to 1:30, or from 1:2 to 1:10. Within the above range, the composition for the aerogel-containing layer may be coated by controlling the viscosity of the composition for the aerogel-containing layer.

The composition for the aerogel-containing layer may be prepared using the solvent, the fibrous support, the aerogel, and the binder.

According to one example embodiment, the composition for the aerogel-containing layer may be prepared by preparing a first mixed solution by mixing the binder with the solvent (first step); preparing a second mixed solution by mixing the aerogel with the first mixed solution (second step); and preparing the composition for the aerogel-containing layer by mixing the fibrous support with the second mixed solution (third step). In the preparing of the first mixed solution, the dispersant, the silane-based compound, the additive, or the like may be additionally mixed.

In each, or at least one, of the first step, the second step, and the third step, the mixing may be performed using a mixer. For example, a planetary mixer, a Thinky mixer, or the like may be included as the mixer.

The planetary mixer may include one or more types of planetary blades, and one or more types of high-speed dispersion blades. The planetary blades and high-speed dispersion blades continuously rotate about their axes. The rotational speed may be expressed in rpm.

According to one example embodiment, the planetary mixer may include a first blade and a second blade which rotational axes are different. For example, the first blade may be a low-speed blade, and the second blade may be a high-speed blade. Herein, the low speed and high speed refer to relative rotational speeds. For example, the first blade may be an open blade, and the second blade may be a Despa blade. For example, the rotational speed of the first blade may range from about 10 rpm to about 100 rpm, or from 10 rpm to 60 rpm. The rotational speed of the second blade may range from 100 rpm to 2,000 rpm.

The aerogel-containing layer may be prepared by applying and drying the composition for the aerogel-containing layer. The drying may be performed at a temperature ranging from about 25° C. to about 100° C., from 45° C. to 90° C., or from 60° C. to 85° C. Within the above range, an aerogel-containing layer with desired or improved mechanical strength may be formed without a separate adhesive member or an adhesive, while reducing or preventing peeling between the first base layer and the aerogel-containing layer and peeling between the aerogel-containing layer and the second base layer.

Rechargeable lithium battery module:

Another example embodiment includes a rechargeable lithium battery module including a plurality of battery cells that face each other; and heat insulating sheets between the plurality of battery cells.

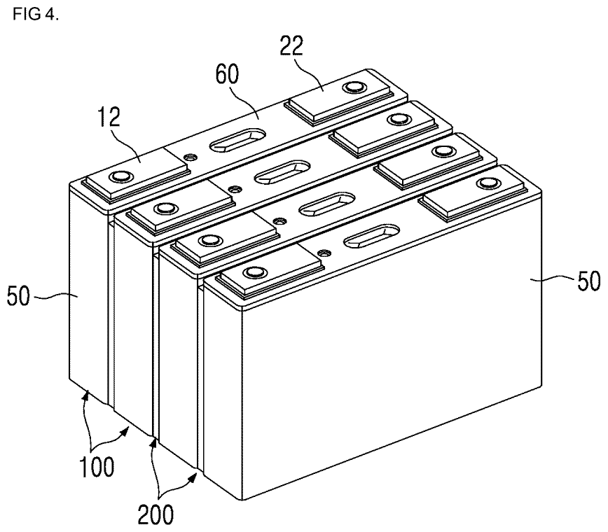

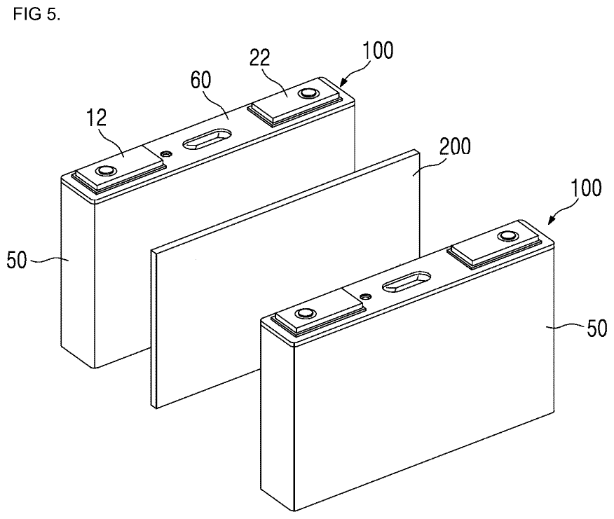

FIGS. 4 and 5 are a perspective view and an exploded perspective view, respectively, of a rechargeable lithium battery module, according to one example embodiment.

Referring to FIGS. 4 and 5, a rechargeable lithium battery module may include a plurality of battery cells 100 that face each other, and heat insulating sheets 200 between the battery cells 100.

The heat insulating sheet 200 for a rechargeable lithium battery may have a plate shape. One surface of the heat insulating sheet 200 may come in contact with one surface of one battery cell 100, and the other surface of the heat insulating sheet 200 opposite to the one surface thereof may come in contact with one surface of another battery cell 100.

The battery cell 100 may include a case 50 configured to accommodate an electrode assembly including a positive electrode and a negative electrode, a cap plate 60 coupled to the case 50 to seal the case 50, and a positive electrode terminal 12 and a negative electrode terminal 22 electrically connected to the positive electrode and the negative electrode of the electrode assembly and protruding to the outside of the cap plate 60.

The positive electrode may include a current collector and a positive electrode active material layer formed on the current collector. The positive electrode active material layer may include a positive electrode active material and further include a binder and/or a conductive additive.

The content of the positive electrode active material may range from about 90 wt % to about 99.5 wt % with respect to 100 wt % of the positive electrode active material layer, and the content of the binder and the content of the conductive additive may each be in a range of 0.5 wt % to 5 wt % with respect to 100 wt % of the positive electrode active material layer.

Al may be included as the current collector, but the current collector is not limited thereto.

As the positive electrode active material, a compound capable of reversible intercalation and deintercalation of lithium (a lithiated intercalation compound) may be included. For example, one or more of composite oxides of lithium and a metal such as or including at least one of cobalt, manganese, nickel and a combination thereof may be included.

The composite oxides may be or include lithium transition metal composite oxides. Examples of the composite oxides may include at least one of lithium nickel oxide, lithium cobalt oxide, lithium manganese oxide, a lithium iron phosphate compound, cobalt-free nickel-manganese oxide, or a combination thereof.

As one example, a compound represented by any one of the following chemical formulas may be included as the composite oxide. LiₐA_{1-b}X_{b}O_{2-c}D_{c} (0.90≤a≤1.8, 0≤b≤0.5, 0≤c≤0.05); LiₐMn_{2-b}X604-D. (0.90≤a≤1.8, 0≤b≤0.5, 0≤c≤0.05); LiₐNi_{1-b-c}CO_{b}X_{c}O_{2-α}D_{α} (0.90≤a≤1.8, 0<b>0.5, 0≤c≤0.5, 0<α<2); LiₐNi_{1-b-c}Mn_{b}X_{c}O_{2-α}D_{α} (0.90≤a≤1.8, 0<b>0.5, 0≤c≤0.5, 0<a<2); LiₐNi_{b}Co_{c}L_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001<b≤0.1); LiₐMn₂G_{b}O₄ (0.90≤a≤1.8, 0.001<b>0.1); LiₐMn_{1-g}G_{g}PO₄ (0.90≤a≤1.8, 0≤g<0.5); Li_{(3-f})Fe₂(PO₄)₃(0≤f≤2); LiₐFePO₄(0.90≤a≤1.8).

In the above chemical formulas, A is or includes at least one of Ni, Co, Mn, or a combination thereof; X is or includes at least one of Al, Ni, Co, Mn, Cr, Fe, Mg, Sr, V, a rare earth element, or a combination thereof; D is or includes at least one of O, F, S, P, or a combination thereof; G is or includes at least one of Al, Cr, Mn, Fe, Mg, La, Ce, Sr, V, or a combination thereof; and L¹ is or includes at least one of Mn, Al, or a combination thereof.

The negative electrode includes a current collector, and a negative electrode active material layer located on the current collector. The negative electrode active material layer may include a negative electrode active material, and may further include a binder and/or a conductive additive.

For example, the negative electrode active material layer may include about 90 wt % to about 99 wt % of the negative electrode active material, about 0.5 wt % to about 5 wt % of the binder, and about 0 wt % to about 5 wt % of the conductive additive.

The negative electrode active material includes at least one of a material capable of reversible intercalation/deintercalation of lithium ions, lithium metal, a lithium metal alloy, a material capable of doping and dedoping lithium, or a transition metal oxide.

The material capable of reversible intercalation/deintercalation of lithium ions is or includes a carbon-based negative electrode active material, and may include, for example, crystalline carbon, amorphous carbon, or a combination thereof. Examples of the crystalline carbon may include graphite such as natural graphite or artificial graphite, and examples of the amorphous carbon may include at least one of soft carbon, hard carbon, mesophase pitch carbide, and calcinated coke.

At least one of a Si-based negative electrode active material or a Sn-based negative electrode active material may be included as the material capable of doping and dedoping lithium. The Si-based negative electrode active material may be or include at least one of silicon, a silicon-carbon composite, SiOx (0<x<2), an Si-based alloy, or a combination thereof.

The silicon-carbon composite may be or include a composite of silicon and amorphous carbon. According to one example embodiment, the silicon-carbon composite may include a silicon particle and amorphous carbon coated on a surface of the silicon particle.

The silicon-carbon composite may further include crystalline carbon. For example, the silicon-carbon composite may include a core including crystalline carbon and a silicon particle, and an amorphous carbon coating layer located on a surface of the core.

A nonaqueous binder, an aqueous binder, a dry binder, or a combination thereof may be included as the binder. When the aqueous binder is included as the negative electrode binder, a cellulose-based compound that can impart viscosity may be further included.

As the negative electrode current collector, at least one of copper foil, nickel foil, stainless steel foil, titanium foil, nickel foam, copper foam, a polymer substrate having a conductive metal coated thereon, or combinations thereof, may be included. An electrolyte for a rechargeable lithium battery includes a nonaqueous organic solvent and a lithium salt.

The nonaqueous organic solvent is configured as a medium through which ions involved in an electrochemical reaction of a battery can move.

The nonaqueous organic solvent may be or include at least one of a carbonate-based, ester-based, ether-based, ketone-based, or alcohol-based solvent, an aprotic solvent, or a combination thereof. Any of the above may be included alone as the nonaqueous organic solvent, or two or more of the above may be mixed as the nonaqueous organic solvent.

For example, when the carbonate-based solvent is included, a cyclic carbonate and a chain carbonate may be mixed.

A separator may be present between a positive electrode and a negative electrode according to the type of rechargeable lithium battery. At least one of polyethylene, polypropylene, polyvinylidene fluoride, or a multi-layer film of two or more thereof, may be included as the separator.

The separator may include a porous base and a coating layer located on one surface, or on both surfaces, of the porous base, and including an organic material, an inorganic material, or a combination thereof.

The organic material may include a polyvinylidene fluoride-based polymer or a (meth)acryl-based polymer.

The inorganic material may include an inorganic particle such as or including at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but is not limited thereto.

The organic material and inorganic material may be mixed in a single coating layer, or may be in a form in which a coating layer including the organic material and a coating layer including the inorganic material are stacked.

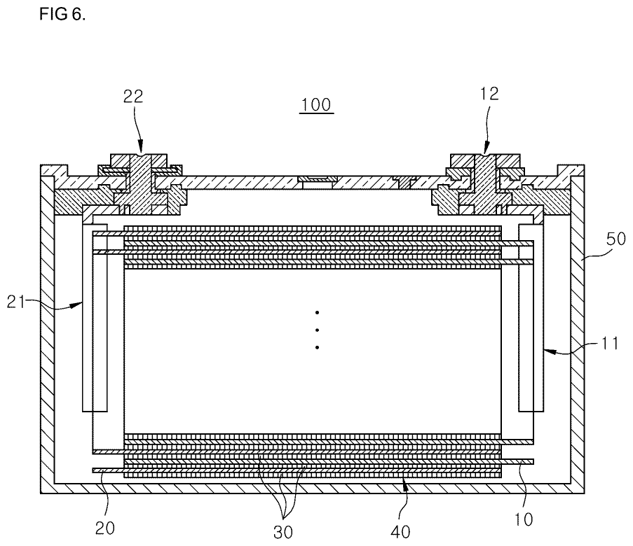

FIG. 6 is a cross-sectional view schematically illustrating the battery cell 100, according to one example embodiment.

Referring to FIG. 6, the battery cell 100 may include an electrode assembly 40 including a positive electrode 10, a negative electrode 20, and a separator 30 interposed between the positive electrode 10 and the negative electrode 20, a case 50 in which the electrode assembly 40 is accommodated, a positive electrode lead tab 11 connected to the positive electrode 10, a positive electrode terminal 12 connected to the positive electrode lead tab 11, a negative electrode lead tab 21 connected to the negative electrode 20, and a negative electrode terminal 22 connected to the negative electrode lead tab 21.

The rechargeable lithium battery module according to one example embodiment may be applicable to, e.g., vehicles, mobile phones, and/or various other forms of electric devices, but the present disclosure is not limited thereto.

The rechargeable lithium battery module according to the above-described example embodiment may be included in manufacturing a battery pack.

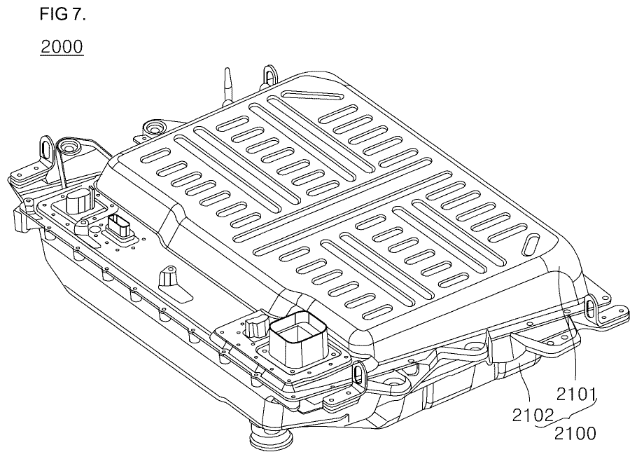

FIG. 7 is a view illustrating a battery pack according to one example embodiment.

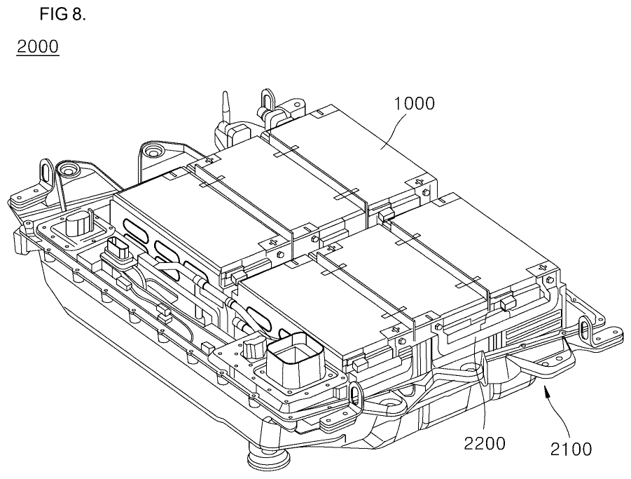

FIG. 8 is a view illustrating a battery pack according to one example embodiment.

A battery pack 2000 according to one example embodiment includes an assembly of electrically connected individual batteries and a pack case accommodating the individual batteries. In the drawings, for convenience of illustration, components such as a busbar, a cooling unit, an external terminal, and the like for electrical connection of batteries have been omitted.

For example, the battery pack 2000 may include a plurality of battery modules 1000 (for example, including the battery module described above with reference to FIG. 5) and a pack case 2100 for accommodating the battery modules 1000. For example, the pack case 2100 may include first and second pack cases 2101 and 2102 coupled to each other in directions facing each other while the plurality of battery modules 1000 are interposed therebetween. The plurality of battery modules 1000 may be electrically connected to each other using a busbar 2200, or the plurality of battery modules 1000 may be electrically connected to each other in series or in parallel or by a combination of serial and parallel connections to obtain a required electrical output.

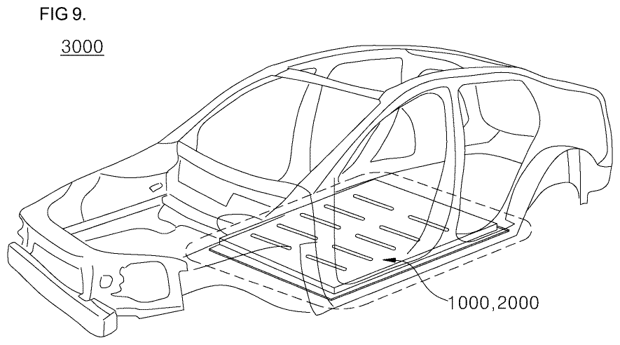

FIG. 9 is a view illustrating a vehicle body and vehicle body components, according to one example embodiment.

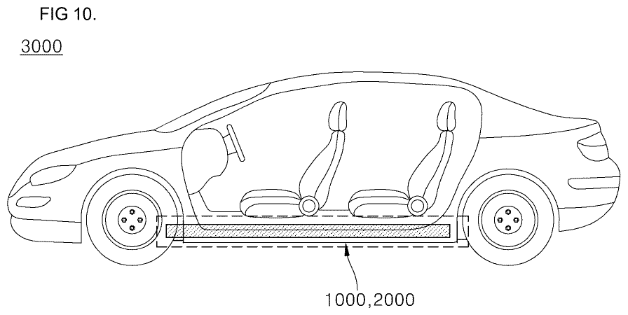

FIG. 10 is a view illustrating a vehicle body and vehicle body components, according to one example embodiment.

The battery pack 2000 according to one example embodiment described above with reference to FIGS. 7 and 8 may be mounted in a vehicle 3000. For example, the vehicle 3000 may be an electric vehicle, a hybrid vehicle, or a plug-in hybrid vehicle. The vehicle may be a four-wheel vehicle or a two-wheel vehicle, or another type of vehicle.

As illustrated in FIGS. 9 and 10, the vehicle 3000 according to one example embodiment includes the battery modules 1000 and/or the battery pack 2000 including the battery modules 1000 according to one example embodiment of the present disclosure. The vehicle 3000 operates by receiving power from the battery modules 1000 and/or the battery pack 2000 including the battery modules 1000 according to one example embodiment of the present disclosure.

Hereinafter, examples and comparative examples of the present disclosure are described. However, the following examples are merely one embodiment of the present disclosure, and the present disclosure is not limited to the following examples.

### EXAMPLE 1

### Preparation of Composition for Aerogel-Containing Layer

Polyvinyl alcohol (PVA, Sigma-Aldrich Co., Ltd.) as a binder was input to deionized water as a solvent and mixed at 30 rpm with an open blade and at 700 rpm with a Despa blade to prepare a first mixed solution. An aerogel (having a BET specific surface area of 800 m²/g) was input to the first mixed solution and mixed at 70 rpm with the open blade and at 1,500 rpm with the Despa blade to prepare a second mixed solution. Glass wool was input to the second mixed solution and mixed at 30 rpm with the open blade and at 1,200 rpm with the Despa blade to prepare a composition for an aerogel-containing layer. A planetary mixer (DNTEK Co., Ltd., PT-005) was used for mixing.

The prepared composition for an aerogel-containing layer was in the form of a slurry and included, based on solid content, 45 wt % glass wool, 10 wt % PVA, and 45 wt % aerogel. The prepared composition for an aerogel-containing layer did not include a thermally conductive material.

### Manufacture of Heat Insulating Sheet

The prepared composition for an aerogel-containing layer was applied on a mica sheet (Famica, Muscovite) having a thickness of 0.1 mm, which was a first base layer, to form a coating film.

An aqueous solution including titania powder (average particle diameter D50: 50 nm) as a thermally conductive material was sprayed on the coating film.

The prepared composition for an aerogel-containing layer was applied again on the aqueous solution. A mica sheet (Famica, Muscovite) having a thickness of 0.1 mm as a second base layer was stacked thereon and coated by a roll rolling method.

Then, drying was performed for 24 hours at 60° C. to manufacture a heat insulating sheet stacked in the order of mica sheet-aerogel-containing layer-mica sheet.

A region without titania powder, a region where titania powder is dispersed at high density, and a region without titania powder were sequentially stacked from the first base layer in the aerogel-containing layer.

The titania powder was included at 3 wt % in the aerogel-containing layer.

### EXAMPLE 2

A heat insulating sheet was manufactured in the same manner as in Example 1, with a difference that in Example 1, copper powder (average particle diameter D50: 10 nm) was used instead of titania powder.

A region without copper powder, a region where copper powder is dispersed at high density, and a region without copper powder were sequentially stacked from the first base layer in the aerogel-containing layer.

The copper powder was included at 3 wt % in the aerogel-containing layer.

### EXAMPLE 3

A heat insulating sheet was manufactured in the same manner as in Example 1, with a difference that in Example 1, aluminum powder (average particle diameter D50: 1,400 nm) was used as a thermally conductive material instead of titania powder. A region without aluminum powder, a region where aluminum powder is dispersed at high density, and a region without aluminum powder were sequentially stacked from the first base layer in the aerogel-containing layer.

The aluminum powder was included at 3 wt % in the aerogel-containing layer.

### EXAMPLE 4

A heat insulating sheet was manufactured in the same manner as in Example 1, with a difference that in Example 1, carbon black powder (average particle diameter D50: 500 nm) was used as a thermally conductive material instead of titania powder. A region without carbon black powder, a region where carbon black powder is dispersed at high density, and a region without carbon black powder were sequentially stacked from the first base layer in the aerogel-containing layer.

The carbon black powder was included at 3 wt % in the aerogel-containing layer.

### Comparative Example 1

A heat insulating sheet was manufactured in the same manner as in Example 1, with a difference that in Example 1, titania powder was not included in the aerogel-containing layer.

### Comparative Example 2

A composition for an aerogel-containing layer was prepared in the same manner as in Example 1.

The prepared composition for an aerogel-containing layer was applied on a mica sheet (Famica, Muscovite) having a thickness of 0.1 mm, which was a first base layer, to form a coating film.

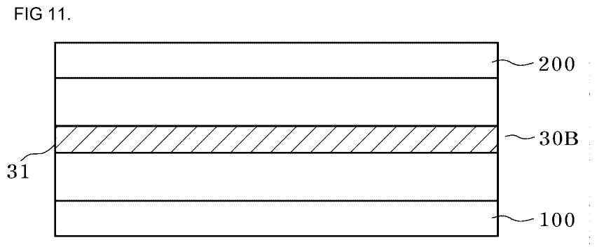

A copper sheet was placed on the coating film, and the prepared composition for an aerogel-containing layer was applied again. A mica sheet (Famica, Muscovite) having a thickness of 0.1 mm as a second base layer was stacked thereon and coated by a roll rolling method. Then, drying was performed for 24 hours at 60° C. to manufacture a heat insulating sheet stacked in the order of mica sheet-aerogel-containing layer-mica sheet. FIG. 11 is a cross-sectional view of the heat insulating sheet of Comparative Example 2. Referring to FIG. 11, an aerogel-containing layer 30B was present between a first base layer 100 and a second base layer 200, and a copper sheet 31 was included in the aerogel-containing layer 30B. The copper sheet was included at 3 wt % in the aerogel-containing layer.

### Comparative Example 3

A composition for an aerogel-containing layer was prepared in the same manner as in Example 1.

The prepared composition for an aerogel-containing layer was applied on a mica sheet (Famica, Muscovite) having a thickness of 0.1 mm, which was a first base layer, to form a coating film.

A copper mesh was placed on the coating film, and the prepared composition for an aerogel-containing layer was applied again. A mica sheet (Famica, Muscovite) having a thickness of 0.1 mm as a second base layer was stacked thereon and coated by a roll rolling method. Then, drying was performed for 24 hours at 60° C. to manufacture a heat insulating sheet stacked in the order of mica sheet-aerogel-containing layer-mica sheet. The copper mesh was included at 3 wt % in the aerogel-containing layer.

### Comparative Example 4

### Preparation of Composition for Aerogel-Containing Layer

Polyvinyl alcohol (PVA, Sigma-Aldrich Co., Ltd.) as a binder and copper powder were input to deionized water as a solvent and mixed at 30 rpm with an open blade and at 700 rpm with a Despa blade to prepare a first mixed solution. An aerogel (having a BET specific surface area of 800 m²/g) was input to the first mixed solution and mixed at 70 rpm with the open blade and at 1,500 rpm with the Despa blade to prepare a second mixed solution. Glass wool was input to the second mixed solution and mixed at 30 rpm with the open blade and at 1,200 rpm with the Despa blade to prepare a composition for an aerogel-containing layer. A planetary mixer (DNTEK Co., Ltd., PT-005) was used for mixing.

The prepared composition for an aerogel-containing layer was in the form of a slurry and included, based on solid content, 42 wt % glass wool, 10 wt % PVA, 45 wt % aerogel, and 3 wt % copper powder.

### Manufacture of Heat Insulating Sheet

The prepared composition for an aerogel-containing layer was applied on a mica sheet (Famica, Muscovite) having a thickness of 0.1 mm, which was a first base layer, to form a coating film. A mica sheet (Famica, Muscovite) having a thickness of 0.1 mm as a second base layer was stacked on the coating film and coated by a roll rolling method. Then, drying was performed for 24 hours at 60° C. to manufacture a heat insulating sheet stacked in the order of mica sheet-aerogel-containing layer-mica sheet.

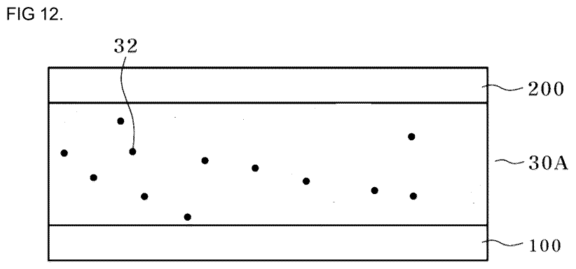

The copper powder was included at 3 wt % in the aerogel-containing layer, and the copper powder was dispersed in the aerogel-containing layer. FIG. 12 is a cross-sectional view of the heat insulating sheet of Comparative Example 4. Referring to FIG. 12, an aerogel-containing layer 30A was present between a first base layer 100 and a second base layer 200, and copper powder 32 was dispersed in the aerogel-containing layer 30A, but the copper powder 32 was not dispersed at high density.

The following physical properties were evaluated for the heat insulating sheets manufactured in Examples and Comparative Examples.

(1) Compression rate (units: %): The manufactured heat insulating sheets were cut into a length of 12 inches and a width of 12 inches to prepare samples, each of the samples was fitted between two aluminum plates having a thickness of 1 T after setting the zero point using universal testing machine (UTM) equipment, and then the samples were compressed from 0 kN to 80 kN at a compression speed of 0.02 mm/see to measure the compression rate through a change in thickness after compression as compared to an initial thickness. The higher the measured value, the higher the compression rate. The higher the compression rate, the better the external stress energy caused by swelling/expansion of battery cells can be absorbed.

(2) Thermal conductivity (units: mW/mK, at 25° C.): Thermal conductivity was evaluated using a heating pressure evaluation method. For example, each of the heat insulating sheets was placed between a pair of facing aluminum plates having a thickness of 1 mm and was placed on a heat press, an upper plate of the heat press was heated to 600° C., and a lower plate of the heat press was maintained at a starting temperature of 40° C. without being heated. Then, the upper and lower plates of the heat press were brought into contact with each other, a pressure of 20 kN was applied, and the temperature and heat transfer rate of the lower plate of the heat press were measured after 11 minutes to calculate thermal conductivity. The lower the thermal conductivity, the better the heat insulating performance.

(3) Emissivity (units:none): The emissivity of the heat insulating sheets was calculated using the following equation given by the Planck's law based on FT-IR analysis results to obtain heat emissivity at 250° C., a thermal runaway starting temperature of a cell.

$$( λ , T ) = \frac{β}{{λ}^{5}} \cdot \frac{1}{{e}^{hc / {k}_{B} T λ} - 1}$$

In the above equation, B=2h2c; h=the Planck constant; b=Wien's displacement; kB=the Boltzmann constant; T=temperature; and c=speed of light.

(4) Flexural modulus (units:MPa): Each heat insulating sheet was prepared into samples according to the ASTM D790 standard, and through the 3-point bending analysis method using a UTM (UT-005E) of MTDI Co., Ltd., the prepared samples were placed on a support, a force was applied to the center of each sample at a speed ranging from 1 mm/min to 10 mm/min, a load was recorded, and an initial slope value obtained by dividing the load by 15% strain was measured to measure the flexural modulus at 15% strain. The lower the flexural modulus, the better the flexibility of the heat insulating sheet.

TABLE 1

| | Example | | | | Comparative Example | | | |
|---|---|---|---|---|---|---|---|---|
| | 1 | 2 | 3 | 4 | 1 | 2 | 3 | 4 |
| Structure | FIG. 1 | FIG. 1 | FIG. 1 | FIG. 1 | — | FIG. 11 | FIG. 11 | FIG. 12 |
| Compression | 44.3 | 43.3 | 41.5 | 43.1 | 43.4 | 39.3 | 41.5 | 41.8 |
| rate | | | | | | | | |
| Thermal | 0.015 | 0.016 | 0.025 | 0.019 | 0.021 | 0.045 | 0.035 | 0.033 |
| conductivity | | | | | | | | |
| Emissivity | 0.632 | 0.682 | 0.611 | 0.721 | 0.532 | 0.814 | 0.782 | 0.662 |
| Flexural | 0.151 | 0.155 | 0.168 | 0.160 | 0.150 | 0.804 | 0.584 | 0.161 |
| modulus | | | | | | | | |

As shown in Table 1 above, the heat insulating sheets of Examples had desired or improved heat insulating performance due to having low thermal conductivity and high emissivity and also had desired or improved compression properties and flexibility.

On the other hand, the heat insulating performance, compression properties, and flexibility of the heat insulating sheets of Comparative Examples were inferior to the heat insulating performance, compression properties, and flexibility of the heat insulating sheets of Examples.

A heat insulating sheet for a rechargeable lithium battery according to one embodiment exhibits desired or improved heat insulating performance, thereby reducing or suppressing heat propagation and/or heat transfer in a module, and improving the safety of the module.

A heat insulating sheet for a rechargeable lithium battery according to one example embodiment exhibits desired or improved compression properties, thereby increasing the service life of a battery module.

Although example embodiments of the present disclosure have been described above, the present disclosure is not limited thereto and may be modified in any form within the scope of the claims, the detailed description of the present disclosure, and the accompanying drawings, and the modifications also fall within the scope of the present disclosure.

What is claimed is:

1. A heat insulating sheet for a rechargeable lithium battery, the heat insulating sheet comprising:
a first base layer, an aerogel-containing layer, and a second base layer that are stacked together,
wherein the aerogel-containing layer includes a thermally conductive material-containing region, and
a thermally conductive material is dispersed in the thermally conductive material-containing region.

2. The heat insulating sheet of claim 1, wherein the thermally conductive material is present at a density of about 0.02 to about 7.46×10¹² per unit area (1 cm²) in the thermally conductive material-containing region.

3. The heat insulating sheet of claim 1, wherein the thermally conductive material is included in an amount ranging from about 0.001 wt % to about 10 wt % in the aerogel-containing layer.

4. The heat insulating sheet of claim 1, wherein the thermally conductive material comprises one or more of titania, copper, aluminum, and carbon black.

5. The heat insulating sheet of claim 1, wherein the thermally conductive material has an average particle diameter D50 ranging from about 10 nm to about 5,000 nm.

6. The heat insulating sheet of claim 1, wherein the aerogel-containing layer further comprises a region not including the thermally conductive material.

7. The heat insulating sheet of claim 6, wherein the region not including the thermally conductive material, the thermally conductive material-containing region, and the region not including the thermally conductive material are formed from the first base layer in the aerogel-containing layer.

8. The heat insulating sheet of claim 7, wherein a thickness ratio of the region not including the thermally conductive material, the thermally conductive material-containing region, and the region not including the thermally conductive material is in a range of about 20% to 60%: 1% to 20%: 20% to 60% when the overall thickness of the aerogel-containing layer is 100%.

9. The heat insulating sheet of claim 1, wherein the aerogel-containing layer comprises the thermally conductive material, a fibrous support, an aerogel, and a binder.

10. The heat insulating sheet of claim 9, wherein the fibrous support comprises glass wool.

11. The heat insulating sheet of claim 9, wherein the binder comprises a polyvinyl alcohol-based binder.

12. The heat insulating sheet of claim 9, wherein the aerogel-containing layer comprises:
a range of about 10 wt % to about 70 wt % of the fibrous support;
a range of about 10 wt % to about 70 wt % of the aerogel;
a range of about 0.5 wt % to about 20 wt % of the binder; and
a range of about 0.001 wt % to about 10 wt % of the thermally conductive material.

13. The heat insulating sheet of claim 1, wherein at least one of the first base layer and the second base layer comprises a mica sheet.

14. A rechargeable lithium battery module comprising:
a plurality of battery cells that face each other; and
the heat insulating sheet of claim 1 between the plurality of battery cells.
